(19) United States
(12) Patent Application Publication
(10) Pub. No.: US 2024/0411153 A1
(43) Pub. Date: Dec. 12, 2024

(54) NON-ORTHOGONAL AND NON-SYMMETRIC CONTACT LENS AND ITS OPTICAL ZONE POWER DISTRIBUTION DESIGN METHOD

(71) Applicant: BRIGHTEN OPTIX CORP., Taipei (TW)

(72) Inventors: Wen-Kai LI, Taipei (TW); I-Tsung WU, Taipei (TW); Wen-Pin LIN, Taipei (TW)

(21) Appl. No.: 18/441,270

(22) Filed: Feb. 14, 2024

Related U.S. Application Data
(63) Continuation-in-part of application No. 18/330,916, filed on Jun. 7, 2023.

(30) Foreign Application Priority Data
Oct. 27, 2023 (TW) 112141367

(51) Int. Cl. G02C 7/02; G02C 7/04

(52) U.S. Cl. CPC G02C 7/028; G02C 7/044; G02C 2202/04

(57) ABSTRACT

The invention relates to a non-orthogonal and non-symmetric contact lens and its optical zone power distribution design method, which involves planning annular curves at predetermined positions in the central optical zone of the contact lens, then, designing the plural curvature value on the radial curves on the annular curves in the central optical zone, and then designing non-orthogonal and non-symmetric curvature changes for the relative position at the central optical zone based on the changes in plural curvature values. It can form a non-orthogonal and non-symmetric curved surface in the central optical zone, and then complete the design of the power distribution of the central optical zone of the contact lens to achieve the purpose of stabilizing the contact lens power, correcting regular and irregular astigmatism, and obtaining clear vision.

This application is a Continuation-In-Part of application Ser. No. 18/330,916, filed on Jun. 7, 2023, for which priority is claimed under 35 U.S.C. § 120, the entire contents of which are hereby incorporated by reference.

This application claims the priority benefit of Taiwan patent application number 112141367, filed on Oct. 27, 2023.

### BACKGROUND OF THE INVENTION

### 1. Field of the Invention

The present invention provides a non-orthogonal and non-symmetric contact lens and its optical zone power distribution design method, which is to obtain an annular curve at a predetermined position in the central optical zone of the contact lens, and use the curvature value of the annular curve to design the curvature of a non-orthogonal and non-symmetric radial curve in the central optical zone to form a predetermined curved surface, achieving the purpose of clearing the lens power of the contact lens and correcting astigmatism.

### 2. Description of the Related Art

The reason why people develop myopia, also known as short-sightedness, is due to the mismatch between the focusing power of the eye and the length of the eye. It may be that the axial length of the eye is too long or the curvature of the cornea is too steep. When the total focal power of the eye is too high or too strong, it will cause the light from the distant object to focus in front of the retina, causing the visual imaging to fall in front of the retina, resulting in blurry visual image. Therefore, in order to correct myopia, it is necessary to reduce the power of an eye. Since the light bending ability of the cornea accounts for about 80% of the whole eye, it is only necessary to reduce the refractive power of the cornea to achieve the effect of correcting myopia.

However, the current optical design of lenses mainly revolves around spherical surfaces, aspherical surfaces, astigmatism, and free-form surfaces. Both spherical surfaces and aspherical surfaces are a type of symmetric design and are mainly designed for a single curvature or aspherical surface formula. Astigmatism and free-form surface designs are non-symmetric designs. Astigmatism design uses biaxial design to perform rate or aspheric design on two mutually perpendicular axes. Free-form surfaces use a variety of different free-form surface formulas, including spline lines, Zernike, etc., to customize designs for different areas. Since the astigmatism design is limited to mutually perpendicular axes, instability may easily occur on some corneas, resulting in insufficient lens power and difficulty in obtaining clear vision.

### SUMMARY OF THE INVENTION

The main object of the present invention is to provide a non-orthogonal and non-symmetric contact lens optical zone power distribution design method, which involves planning at least one or more annular curves at predetermined positions in the central optical zone of the contact lens, then, calculating the curvature of at least one or more radial curves of the annular curve along the axial direction to obtain plural curvature value, and then designing non-orthogonal and non-symmetric curvature changes for the relative position at the central optical zone based on the changes in plural curvature values. It can form a non-orthogonal and non-symmetric curved surface in the central optical zone, and then complete the design of the power distribution of the central optical zone of the contact lens to achieve the purpose of stabilizing the contact lens power, correcting regular and irregular astigmatism, and obtaining clear vision.

Another object of the present invention is that the contact lens takes the center of the circle as the reference point and obtains at least one annular curve around the center of the circle in a clockwise or counterclockwise manner within the central optical zone, and the at least one annular curve is based on the center of the circle, and then a constant periodic continuous function or a non-constant periodic continuous function is used to numerically design the curvature of the curvature curve of the at least one annular curve, wherein the periodic function of the constant periodic can be various periodic function curves such as sine wave, square wave or sawtooth wave; the continuous function z=f(θ) with a non-constant periodic can be a polynomial, exponential function, Fourier, gaussian, sum of sine or Weibull of the function and other equations. Still another object of the present invention is that the non-orthogonal and non-symmetric contact lens optical design method uses the center of the circle of the contact lens as the reference point and rotates clockwise or counterclockwise along the central optical zone in the axial direction, and then carry out the curvature design of the at least one radial curve on at least one annular curve in the central optical zone. When designing the central optical zone of the contact lens, it is implemented through the following calculation steps: (1) first determine the position of the at least one annular curve on the surface of the central optical zone of the contact lens; (2) carry out the numerical design of the curvature of the at least one annular curve; (3) calculate the first design point of the central optical zone (the center of the circle of the contact lens) and the curvature design of the at least one annular curve; (4) using the first point and the curvature of the at least one annular curve, the end point (the last point of the adjacent connecting position between the central optical zone and the peripheral positioning zone) is calculated through functional equations, so that the optimized radial curve of the non-orthogonal and non-symmetric annular design along the central optical zone is obtained; and (5) repeat the above step (4) to gradually complete the design of the different curvature changes of the least one or more radial power distribution curves presented by 0°˜360° in the central optical zone and form a non-orthogonal and non-symmetric curved surface.

Still, another object of the present invention is that the curvature positions of the at least one radial curve on the at least one annular curve of the central optical zone surface with different values of curvature, the calculation method is the function z=f(θ) of at least one or more curvatures and angles, that is, any point a in the function f(θ) conforms to equation (1): lim_{θ→a+}f(θ)=f(a), and lim_{θ→a}f(θ)=f(a), where the function z can be any function z=f(θ); for example: polynomial, exponential function, Fourier, gaussian, sum of sine or Weibull, etc. are applicable equations.

Still, another object of the present invention is that the central optical zone is a curvature design method of one or more segments on the at least one annular curve, and the at least one radial curve of the central optical zone is calculated, and the calculation is done by equation (1) (which is the sag equation):

$$Sag = \frac{{R}_{0} - \sqrt{{R}_{0}^{2} - {y}_{0}^{2} p}}{p} ( mm ) ,$$

wherein R₀ is the curvature of the highest point on said at least one radial curve of said central optical zone, the p=1−e², the e is the eccentricity, and the y₀ is the radius of said central optical zone; the edge b (bordering) of said central optical zone (the circumferential edge connected to said peripheral positioning zone) is back calculated by the diameter of said contact lens and the peripheral curvature.

Still another object of the present invention is that the function z is provided as an equation (2) for calculating the curvature of the at least one radial curve on the surface of the central optical zone, the function:

$${z}^{′} = \frac{{CX}^{2}}{1 + \sqrt{1 - ( K + 1 ) {C}^{2} {X}^{2}}} + {A}_{1} X + {A}_{2} {X}^{2} + {A}_{3} {X}^{3} + … + {A}_{n} {X}^{n} ( mm ) ,$$

in the function z: “C=1/R, R is the radius of curvature of the aspherical surface vertex, k=1−e, e is the eccentricity; when k=1, it represents a hyperboloid; when k=−1, it represents a paraboloid; when 0>k>−1, it represents a semi-elliptical sphere symmetrical to the major axis of the ellipse; when k>0, it represents a semi-elliptical sphere symmetrical to the minor axis of the ellipse; when k=0, it represents a sphere; the A1, A2, A3˜An, etc. are the high-order coefficients of the aspheric surface; using equation (2) to calculate the distance (x1) between the curvature of the at least one annular curve and the center of the circle along the central optical zone, the end point of the edge b (bordering) of the central optical zone (the circumferential edge connected to the peripheral positioning zone) is obtained.

Still another object of the present invention is that the equation calculates the curvature of the at least one radial curve of the central optical zone through equation (3): the

$$W ( r , θ ) = {\sum }_{n , m} {C}_{n}^{m} {Z}_{n}^{m} ( r , θ ) ( mm ) ,$$

aspheric surface angle (θ) of the function z=f(θ) is calculated, where Q is the coordinate position of any point a on the aspheric surface of said at least one annular curve on the surface of said central optical zone of the function z. This equation (3) calculates the aspheric angle (θ) of the function z=f(θ), wherein, the coordinate position of any point a [Q (x1, Y1), Cartesian coordinates; Q (r, θ), polar coordinates] on the at least one annular curve of the surface of the central optical zone of the function z, Q is the any point a, and this equation (3) is the Zernike formula. Use equation (3) to calculate the radius of curvature (r) of the aspheric surface vertex and the angle of curvature (θ) of the at least one annular curve within the central optical zone, the end point of the edge b (bordering) of the central optical zone (the circumferential edge connected to the peripheral positioning zone) is obtained.

### BRIEF DESCRIPTION OF THE DRAWINGS

FIG. 1 is a plan view of the contact lens of the present invention.

FIG. 2 is a design curve diagram of the annular curve of the contact lens of the present invention.

FIG. 3 is a contact lens design curve diagram of the first embodiment of the present invention.

FIG. 4 is a plan view of a contact lens according to the first embodiment of the present invention.

FIG. 5 is a contact lens design curve diagram of the second embodiment of the present invention.

FIG. 6 is a plan view of a contact lens according to the second embodiment of the present invention.

FIG. 7 is a contact lens design curve diagram of the third embodiment of the present invention.

FIG. 8 is a plan view of a contact lens according to the third embodiment of the present invention.

FIG. 9 is a contact lens design curve diagram of the fourth embodiment of the present invention.

FIG. 10 is a plan view of a contact lens according to the fourth embodiment of the present invention.

FIG. 11 is a partial side view of the contact lens of the present invention.

FIG. 12 is a schematic diagram of the central optical zone of the contact lens of the present invention.

### DETAILED DESCRIPTION OF THE PREFERRED EMBODIMENT

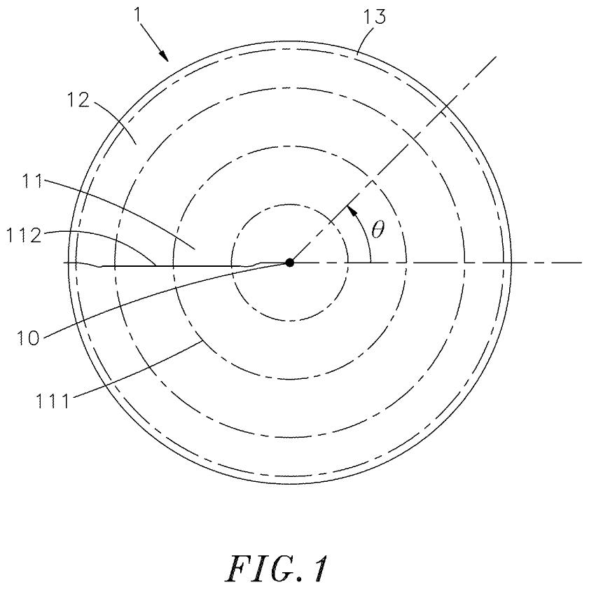

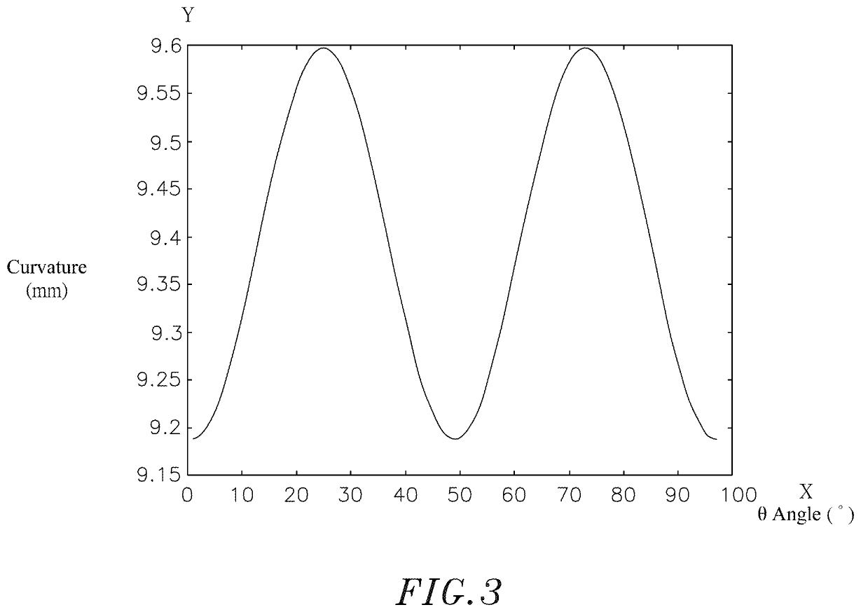

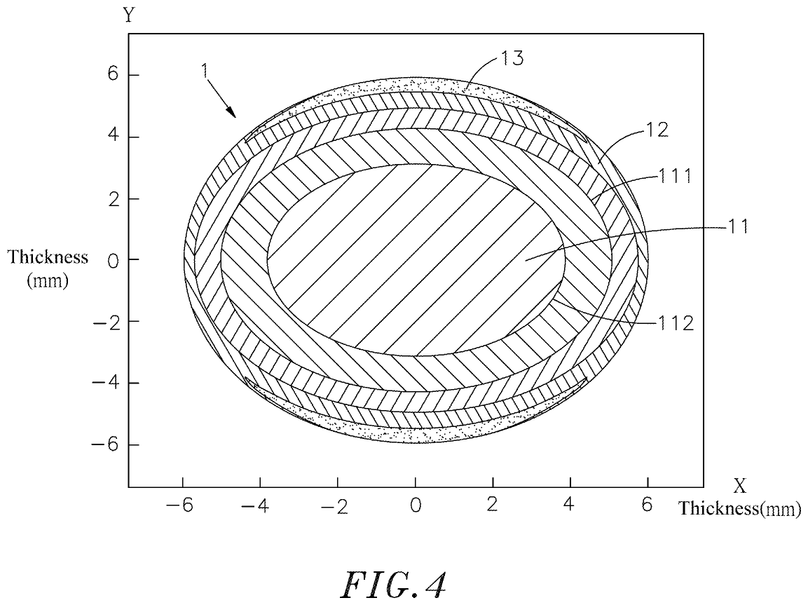

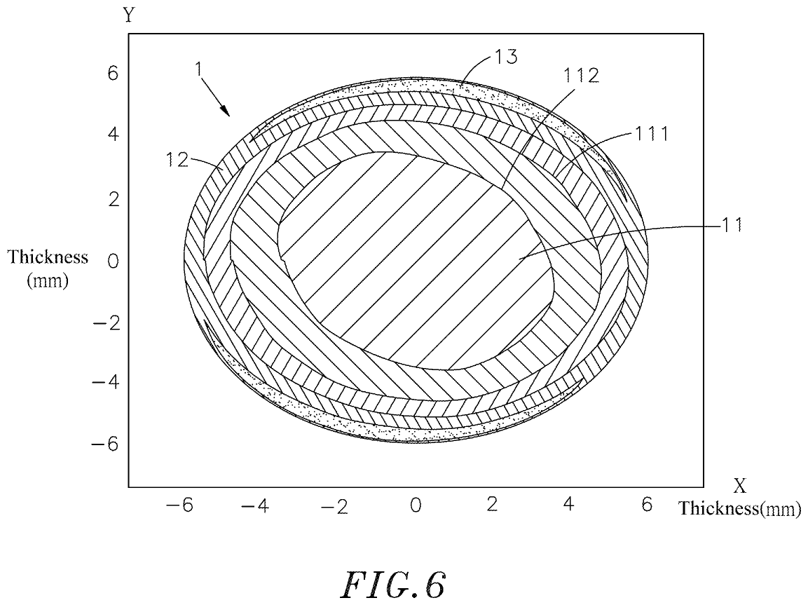

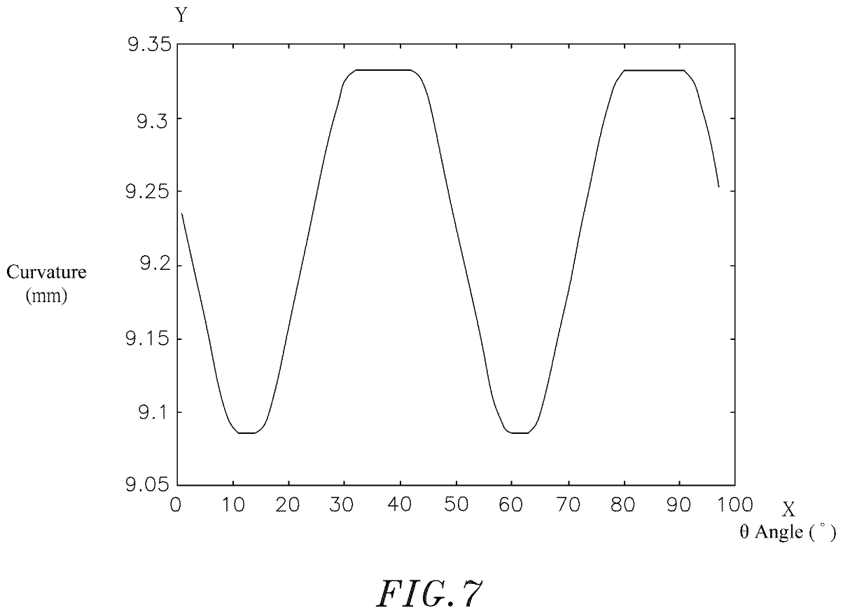

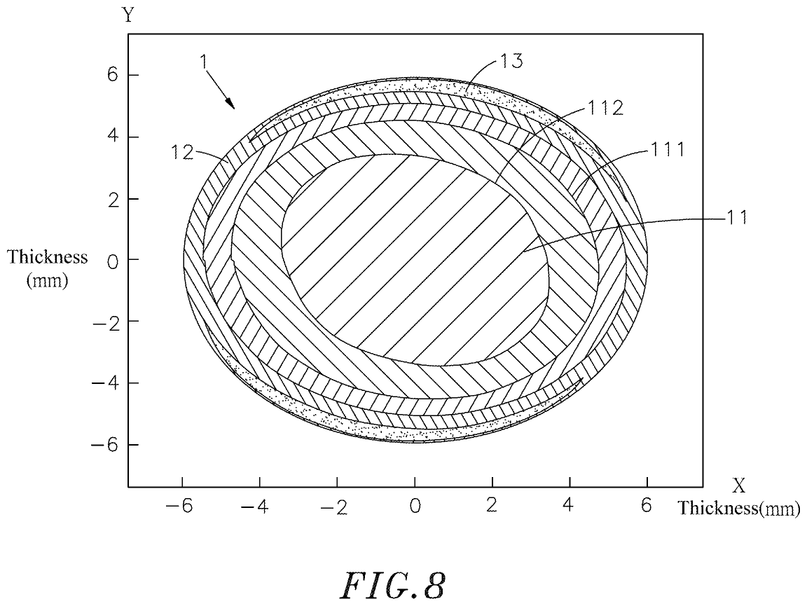

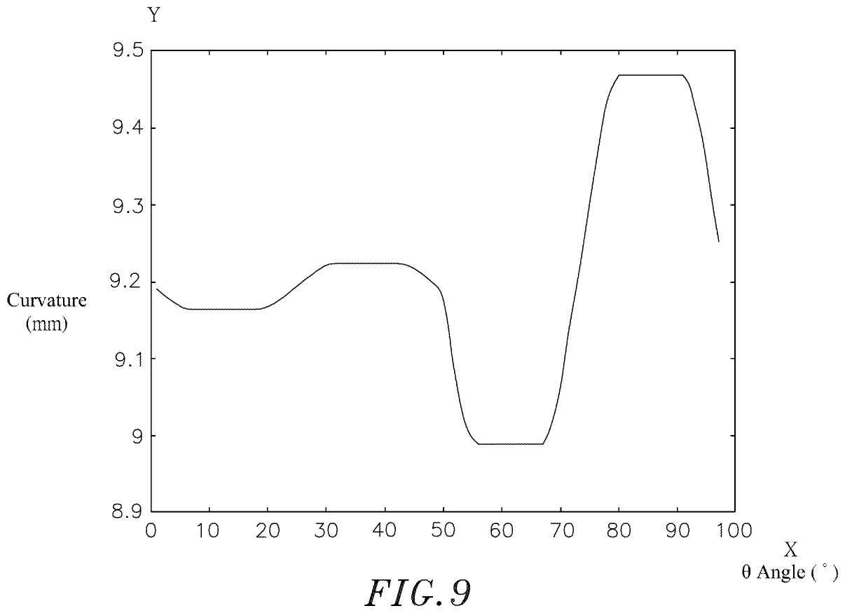

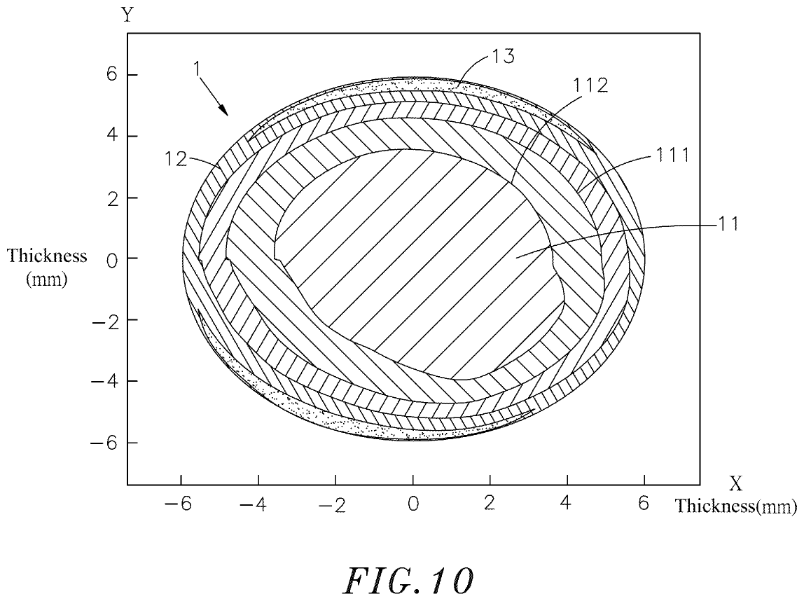

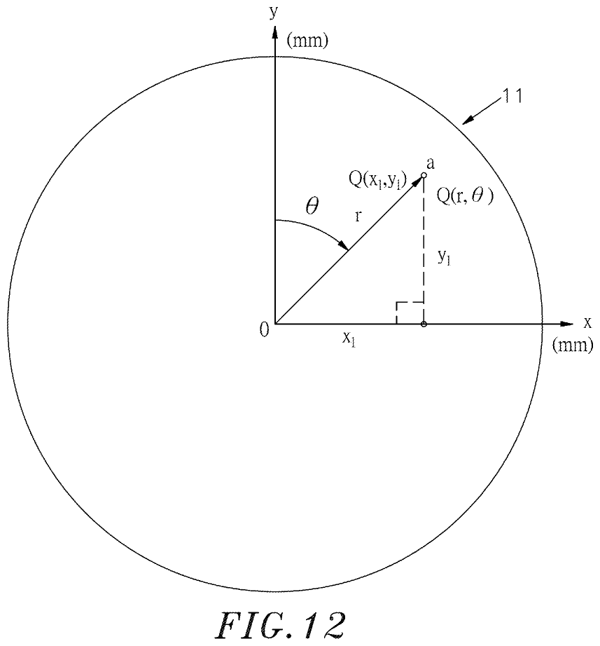

Referring to FIGS. 1-12. It can be clearly seen from the figures that the non-orthogonal and non-symmetric contact lens of the present invention and its optical design method are used, and the contact lens 1 comprises a central optical zone 11, a peripheral positioning zone 12 surrounding the central optical zone 11, and a peripheral curve zone 13 surrounding the peripheral positioning zone 12. The contact lens 1 is designed according to the following steps:

(A01) Plan at least one predetermined position within the central optical zone 11 of the contact lens 1, and design at least one annular curve 111 at the at least one predetermined position.

(A02) Within the range of the central optical zone 11, design the curvature value of the at least one annular curve 111 surrounding the central optical zone 11.

(A03) Based on the change in the curvature value of the at least one annular curve 111 surrounding the central optical zone 11, perform a numerical design of the curvature of a non-orthogonal and non-symmetric radial curve 112 within the range of the central optical zone 11.

(A04) Repeat this step (A03) to form a non-orthogonal and non-symmetric curved surface design in the central optical zone 11.

(A05) Complete the power distribution design of the central optical zone 11 of the contact lens 1.

The above-mentioned contact lens 1 takes the center of the circle 10 as the reference point and obtains the at least one annular curve 111 around the center of the circle 10 in a clockwise or counterclockwise manner within the central optical zone 11. And the at least one annular curve 111 is based on the center of the circle 10 as the reference point, and then the curvature value of the curvature curve of the at least one annular curve 111 is designed using a constant periodic continuous function or a non-constant periodic continuous function. The constant periodic continuous function can be the curve of various periodic functions such as sine wave, square wave or sawtooth wave. A non-constant periodic continuous function z=f(θ) can be the equation of a polynomial, exponential function, Fourier, Gaussian, sum of sine or Weibull of the function.

The above-mentioned method for designing the power distribution of the non-orthogonal and non-symmetric contact lens optical zone of the present invention is to use the center of the circle 10 of the contact lens 1 as the reference point and rotate clockwise or counterclockwise along the central optical zone 11 in the axial direction, and design the curvature of the at least one radial curve 112 on the at least one annular curve 111 on the surface of the central optical zone 11 (which can be the front, that is, the outer surface (that is not attached to the eyeball)), or the back (that is, the surface that is attached to the eyeball) of the central optical zone 11 of the contact lens 1, it is implemented through the following calculation steps

(1) First determine the position of the at least one annular curve 111 on the surface (which can be the front or back) of the central optical zone 11 of the contact lens 1.

(2) Carry out the numerical design of the curvature of the at least one annular curve 111.

(3) Obtain the design of the first point (starting point) of the central optical zone 11 surface (which can be the front or back) as the center of the circle 10 of the contact lens 1 and the curvature design of the at least one annular curve 111.

(4) Using the first point and the curvature of the at least one annular curve 111, the end point (the last point of the adjacent connecting position between the central optical zone 11 and the peripheral positioning zone 12) is calculated through functional equations, so that the optimized radial curve 112 of the non-orthogonal and non-symmetric annular design along the central optical zone 11 is obtained.

(5) Repeat the above step (4) to gradually complete the design of the different curvature changes of the least one non-orthogonal and non-symmetric radial curve 112 on the at least one annular curve 111 in the radial shape presented by 0° ˜360° on the surface (which can be the front or back) of the central optical zone 11.

Therefore, through the implementation of the above steps, the central optical zone 11 of the contact lens 1 of the present invention can have at least one annular curve 111 with at least one different value of curvature on the surface, and the calculation method is the function z=f(θ) of at least one curvature and angle. That is, any point a in the function f(θ) conforms to equation (2): lim_{θ→a+}f(0)=f(a) and lim_{θ→a-}f(0)=f(a), wherein the function z can be any function z=f(θ), such as: polynomial, exponential function, Fourier, Gaussian, sum of sine or Weibull, and other applicable equations. By repeating the calculation of equation (1) function z or equation (2) above, the numerical change of the at least one curvature of the radial shape presented on the at least one radial curve 112 on the surface (which can be the front or back) of the central optical zone 11 within the range of 0° ˜360° can be calculated respectively, so as to design the curvature change of the at least one radial curve 112 on the surface within the central optical zone 11 of the contact lens 1.

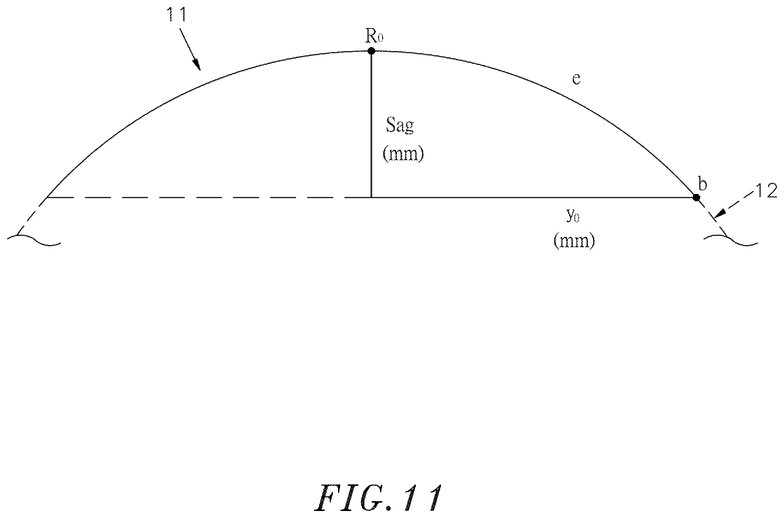

The central optical zone 11 of the contact lens 1 of the present invention is designed to form one or more segments of curvature on the at least one annular curve 111 on the surface of the central optical zone 11 (which can be the front or the back) and calculate at least one radial curve 112 on the surface of the central optical zone 11 (which can be the front or the back). It can be a curve calculation method of one segment or multiple segments (please also refer to FIG. 11), then the calculation is done by equation (1) (which is the sag equation):

$$Sag = \frac{{R}_{0} - \sqrt{{R}_{0}^{2} - {y}_{0}^{2} p}}{p} ( mm ) ,$$

wherein R₀ is the curvature of the highest point on the at least one radial curve 112 of the surface of the central optical zone 11 (which can be the front or back), the p=1−e², the e is the eccentricity, and the y₀ is the radius of the central optical zone 11; the edge b (bordering) of the central optical zone 11 (the circumferential edge connected to the peripheral positioning zone 12) is calculated back by the diameter of the contact lens 1 and the peripheral curvature.

Calculation of the curvature of the at least one radial curve 112 on the surface of the central optical zone 11 of the present invention (which can be the front, that is, the outer surface that is not attached to the eyeball, or the back, that is, the inner surface that is attached to the eyeball), it can be expressed by equation (2) (which can be an aspheric equation). This function:

$$z = \frac{{CX}^{2}}{1 + \sqrt{1 - ( K + 1 ) {C}^{2} {X}^{2}}} + {A}_{1} X + {A}_{2} {X}^{2} + {A}_{3} {X}^{3} + … + {A}_{n} {X}^{n} ) ( mm ) .$$

In the aforementioned function z: “C=1/R, R is the radius of curvature of the aspherical surface vertex, k=1−e, e is the eccentricity. When k=1, it represents a hyperboloid. When k=−1, it represents a paraboloid. When 0>k>−1, it represents a semi-elliptical sphere symmetrical to the major axis of the ellipse. When k>0, it represents a semi-elliptical sphere symmetrical to the minor axis of the ellipse. When k=0, it represents a sphere. The A1, A2, A3˜An, etc. are the high-order coefficients of the aspheric surface. Using equation (2) to calculate the distance (x1) between the curvature of the at least one annular curve 111 and the center of the circle 10 along the central optical zone 11, the end point of the edge b (bordering) of the central optical zone 11 (the circumferential edge connected to the peripheral positioning zone 12) can be obtained.

Furthermore, the calculation of the curvature of the at least one radial curve 112 on the surface of the central optical zone 11 of the present invention, which can be the front, that is, the outer surface that is not attached to the eyeball, or the back, that is, the inner surface that is attached to the eyeball, You can also calculate the aspheric angle (θ) of the function z=f(θ) by equation (3)

$$W ( r , θ ) = {\sum }_{n , m} {C}_{n}^{m} {Z}_{n}^{m} ( r , θ ) ( mm ) ,$$

where Q is the coordinate position of any point a on the aspheric surface of the at least one annular curve 111 on the surface of the central optical zone 11 of the function z. This equation (3) calculates the aspheric angle (θ) of the function z=f(0), wherein, the coordinate position of any point a [Q (x1, Y1), Cartesian coordinates; Q (r, θ), polar coordinates] on the at least one annular curve 111 of the surface of the central optical zone 11 of the function z, which can be the front or the back, Q is the any point a. This equation (3) is the Zernike formula. Using equation (3) to calculate the radius of curvature (r) of the aspherical surface vertex and the angle of curvature (θ) of the at least one annular curve 111 within the central optical zone 11, the end point of the edge b (bordering) of the central optical zone 11 (circumferential edge connected to the peripheral positioning zone 12) can be obtained.

For the central optical zone 11 of the contact lens 1 of the present invention, to carry out the curvature design mode of the at least one radial curve 112 on the at least one annular curve 111, the end point of the edge b (bordering) of the central optical zone 11 (the circumferential edge connected to the peripheral positioning zone 12) can be calculated by equation (1), (2) or (3).

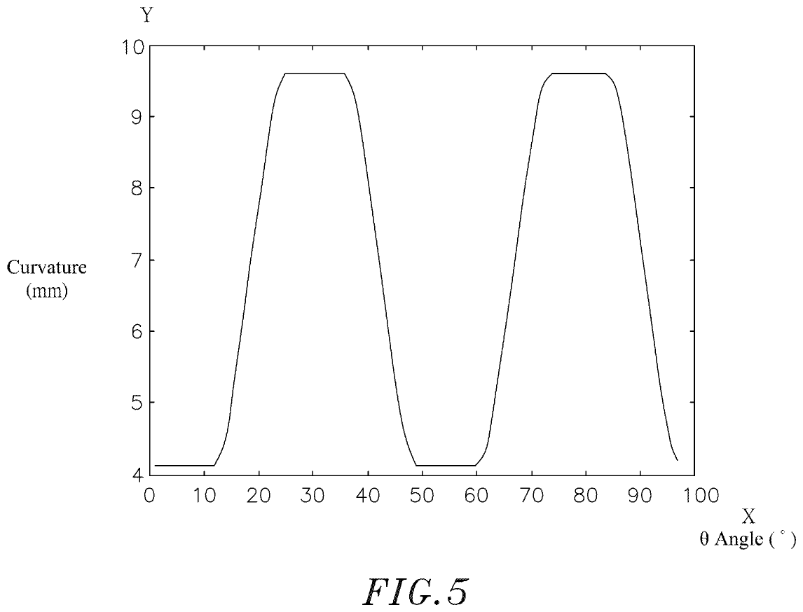

For the central optical zone 11 of the contact lens 1 of the present invention, to carry out the curvature design mode of the at least one annular curve 111, it represents the numerical change of curvature of the central optical zone 11 in different axial directions, then the function lim_{θ→a+}f(0)=f(a), and lim_{θ→a-}f(0)=f(a), for example: f(20.001)=7.001, f(19.999)=6.999 (Please also refer to FIG. 11 and FIG. 5), the “position” of the curvature of the annular curve 111 has a radius (Y₀)=3, R₀=8.0357, p=0.55, e₂=0.45, which is brought into this function. Then through the above equation (1):

$$Sag = \frac{{R}_{0} - \sqrt{{R}_{0}^{2} - {y}_{0}^{2} p}}{p} ( mm ) ,$$

perform calculations, and the curvature of the annular curve 111 on the central optical zone 11 (diameter=6 mm, radius (Y0)=3 mm) R₀=8.0357, P=0.55, e²=0.45 can be obtained, then Sag=0.1407 (mm) of equation (1) (this is a reference data calculated using the radius (Y₀) shown in FIG. 11 as a commonly used predetermined value, and is not the data for the embodiment of this case).

The above contact lens 1 of the present invention can be used in RGP contact lenses, soft contact lenses, scleral lenses or orthokeratology lenses, etc.

The design of the curvature of the at least one non-orthogonal and non-symmetric radial curve 112 on the at least one annular curve 111 on the surface of the central optical zone 11 of the contact lens 1 can be designed according to the preset user's eye conditions, such as the same or different myopia, hyperopia, astigmatism, presbyopia or eyelid shape in the left eye or right eye, etc. The curvature design of the at least one radial curve 112 through the at least one annular curve 111 on the surface (which can be the front, that is, the outer surface that is not attached to the eyeball), or the back (that is, the inner surface that is attached to the eyeball) of the central optical zone 11 of the contact lens 1, because the change in curvature value of the at least one radial curve 112 located in the central optical zone 11 presents a non-orthogonal, non-symmetric design of different or the same curvature value, it can be consistent with the movement of the eyeball (up, down, left, right, etc.) or the blinking between the eyeball and eyelid to match the contact lens 1 when the eyelid blinks. It can provide the wearer wear the contact lens 1 more stable, and has the functions of stabilizing the user's refractive error, correcting astigmatism and other unexpected functions, achieving the purpose of correcting regular and irregular astigmatism of the contact lens 1. You can also get clearer vision when wearing the contact lens 1.

The above-mentioned non-orthogonal and non-symmetric contact lens 1 of the present invention comprises a central optical zone 11, a peripheral positioning zone 12 surrounding the central optical zone 11, and a peripheral curve zone 13 surrounding the peripheral positioning zone 12. The central optical zone 11 is located around the center of the circle 10 of the contact lens 1, and from the center of the circle 10 to the adjacent intersection position of the central optical zone 11 and the peripheral positioning zone 12, the at least one radial curve 112 with non-orthogonal and non-symmetric curvature numerical changes is designed.

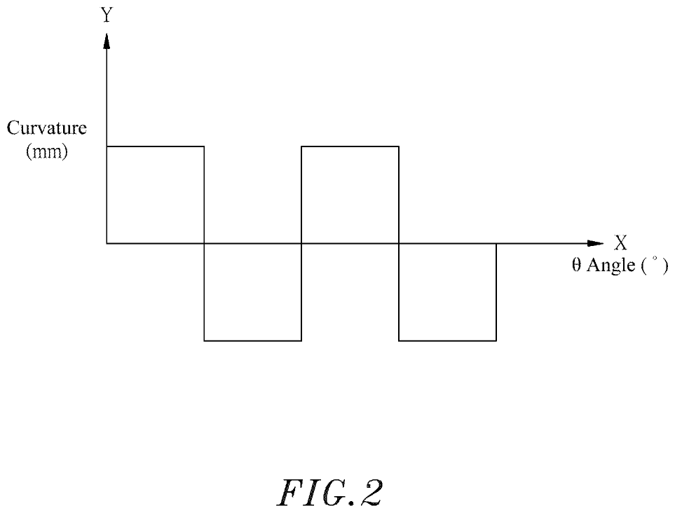

The central optical zone 11 can be a spherical, aspherical, astigmatic, multifocal astigmatic or free-form optical design, and on the surface of the contact lens 1 that can be the front surface (the outer surface that is not attached to the eyeball) or the back surface (the surface that is attached to the eyeball), the curvature design of the at least one annular curve 111 along the axial clockwise or counterclockwise rotation outside the central optical zone 11 is carried out so that a regular or irregular surface with non-orthogonal and non-symmetric curvature changes can be formed on the at least one annular curve 111. The curvature of the at least one annular curve 111 is a constant periodic continuous function along the axis of the central optical zone 11. It can be a sine wave, square wave or sawtooth wave, etc. (Please also refer to FIGS. 2, 3, 5, 7, and 9, where the X-axis is the angle (θ, °) and the Y-axis is the curvature (mm)) of various periodic functions, etc. The curvature of the at least one radial curve 112 is obtained by rotating clockwise or counterclockwise.

What the invention claimed is:

1. An optical design method for designing a non-orthogonal and non-symmetric contact lens comprising a central optical zone, a peripheral positioning zone surrounding said central optical zone, and a peripheral curve zone surrounding said peripheral positioning zone, the optical design method the steps of:
(A01) planning at least one predetermined position within said central optical zone of said contact lens, and designing at least one annular curve at said at least one predetermined position;
(A02) within the range of said central optical zone, designing the curvature value of said at least one annular curve surrounding said central optical zone;
(A03) based on the change in the curvature value of said at least one annular curve surrounding said central optical zone, performing a numerical design of the curvature of a non-orthogonal and non-symmetric radial curve within the range of said central optical zone;
(A04) repeating step (A03) to form a non-orthogonal and non-symmetric curved surface design in said central optical zone; and
(A05) completing the power distribution design of said central optical zone of said contact lens.

2. The optical design method for designing a non-orthogonal and non-symmetric contact lens as claimed in claim 1, wherein in step (A01), based on the center of the circle of said contact lens, said at least one annular curve is planned to surround said center of the circle in a clockwise or counterclockwise manner within said central optical zone.

3. The optical design method for designing a non-orthogonal and non-symmetric contact lens as claimed in claim 2, wherein the curvature value of said at least one annular curve is designed along said center of the circle of said contact lens as a reference point with a constant periodic continuous function or a non-constant periodic continuous function.

4. The optical design method for designing a non-orthogonal and non-symmetric contact lens as claimed in claim 3, wherein said constant periodic continuous function is a sine wave, square wave, or sawtooth wave; any point (a) in the function of non-constant periodic continuous function is an equation of polynomial, exponential function, Fourier, gaussian, sum of sine or Weibull.

5. The optical design method for designing a non-orthogonal and non-symmetric contact lens as claimed in claim 2, wherein the contact lens is rotated clockwise or counterclockwise along the axis of said central optical zone with the center of the circle of the contact lens as the reference point to obtain the curvature of said at least one radial curve on said at least one annular curve in said central optical zone, which is implemented through the following calculation steps:
(1) first determining the position of said at least one annular curve on the surface of said central optical zone of said contact lens;
(2) carrying out the numerical design of the curvature of said at least one annular curve;
(3) obtaining the design of the first point on the surface of said central optical zone (i.e., said center of the circle of said contact lens) and the curvature design of said at least one annular curve;
(4) using said first point and the curvature of said at least one annular curve to calculate the end point through a functional equation, so as to obtain said at least one radial curve of the non-orthogonal and non-symmetric annular design along said central optical zone; and
(5) repeating the above step (4) to gradually complete the design of the design of different curvature changes of said at least one radial curve presented from 0°˜360° within said central optical zone.

6. The optical design method for designing a non-orthogonal and non-symmetric contact lens as claimed in claim 5, wherein said central optical zone is a curvature design method of one or more segments on said at least one annular curve, and said at least one radial curve of said central optical zone is calculated, and the calculation is done by equation (1) (which is the sag equation):
$$Sag = \frac{{R}_{0} - \sqrt{{R}_{0}^{2} - {y}_{0}^{2} p}}{p} ( mm ) ,$$
wherein R₀ is the curvature of the highest point on said at least one radial curve of said central optical zone, the p=1−e², the e is the eccentricity, and the y₀ is the radius of said central optical zone; the edge b (bordering) of said central optical zone (the circumferential edge connected to said peripheral positioning zone) is calculated back by the diameter of said contact lens and the peripheral curvature.

7. The optical design method for designing a non-orthogonal and non-symmetric contact lens as claimed in claim 5, wherein the equation is designed to calculate different changes in the curvature of said at least one annular curve in said central optical zone, and the calculation method is the function z=f(x) of the curvature and angle of said at least one annular curve, that is, any point a in the function f(x) conforms to equation (2): lim_{θ→a+}f(θ)=f(a), and lim_{θ→a-}f(θ)=f(a), where the function z can be any function z=f(θ); the function z is provided as an equation (2) for calculating the different changes in the curvature of said at least one radial curve on the surface of said central optical zone, the function:
$$z = \frac{{CX}^{2}}{1 + \sqrt{1 - ( K + 1 ) {C}^{2} {X}^{2}}} + {A}_{1} X + {A}_{2} {X}^{2} + {A}_{3} {X}^{3} + … + {A}_{n} {X}^{n} ) ( mm ) ,$$
in the function z: “C=1/R, R is the radius of curvature of the aspherical surface vertex, k=1−e, e is the eccentricity; when k=1, it represents a hyperboloid; when k=−1, it represents a paraboloid; when 0>k>−1, it represents a semi-elliptical sphere symmetrical to the major axis of the ellipse; when k>0, it represents a semi-elliptical sphere symmetrical to the minor axis of the ellipse; when k=0, it represents a sphere; the A1, A2, A3˜An, etc. are the high-order coefficients of the aspheric surface; using equation (2) to calculate the distance (x1) between the curvature of said at least one annular curve and said center of the circle along said central optical zone, the end point of the edge b (bordering) of said central optical zone (the circumferential edge connected to said peripheral positioning zone) is obtained.

8. The optical design method for designing a non-orthogonal and non-symmetric contact lens as claimed in claim 5, wherein the equation calculates the curvature of said at least one radial curve of said central optical zone through equation (3):
$$W ( r , θ ) = {\sum }_{n , m} {C}_{n}^{m} {Z}_{n}^{m} ( r , θ ) ( mm ) ,$$
the aspheric surface angle (θ) of the function z=f(θ) is calculated, where Q is the coordinate position of any point a on the aspheric surface of said at least one annular curve on the surface of said central optical zone of the function z. This equation (3) calculates the aspheric angle (θ) of the function z=f(θ), wherein, the coordinate position of any point a [Q (x1, Y1), Cartesian coordinates; Q (r, θ), polar coordinates] on the at least one annular curve of the surface of the central optical zone of the function z, Q is the any point a, and this equation (3) is the Zernike formula.

9. A non-orthogonal and non-symmetric contact lens, comprising a central optical zone, a peripheral positioning zone surrounding said central optical zone and an peripheral curve zone surrounding said peripheral positioning zone, wherein said central optical zone is located around the center of the circle of the contact lens, and at least one radial curvature is obtained on said at least one annular curve from said center of the circle to the adjacent intersection position of said central optical zone and said peripheral positioning zone to form a non-orthogonal, non-symmetric curved surface.

10. The non-orthogonal and non-symmetric contact lens as claimed in claim 9, wherein said central optical zone is an optical design of spherical, aspheric, astigmatism, multifocal astigmatism or free-form surface, and the surface of the contact lens is the front surface (the outer surface that is not attached to the eyeball) or the back surface (the surface that is attached to the eyeball), and is planned to rotate clockwise or counterclockwise along the external axis of said central optical zone to design the curvature of said at least one annular curve; a regular or irregular surface forming a non-orthogonal, non-symmetric curvature of said at least one radial curve on said at least one annular curve, and the curvature of said at least one annular curve is a constant periodic continuous function along the axis of said central optical zone, which can be a sine wave, a square wave or a sawtooth wave and other periodic functions, and the curvature design of said at least one radial curve is performed by rotating clockwise or counterclockwise.
